(19) United States
(12) Patent Application Publication
(10) Pub. No.: US 2022/0067112 A1
(43) Pub. Date: Mar. 3, 2022

(54) MUSICAL ARTIST MATCHING PLATFORM AND METHOD

(71) Applicant: Myles Reid Penny, Mount Laurel, NJ (US)

(72) Inventor: Myles Reid Penny, Mount Laurel, NJ (US)

(21) Appl. No.: 17/249,008

(22) Filed: Feb. 17, 2021

Related U.S. Application Data
(60) Provisional application No. 63/070,360, filed on Aug. 26, 2020.

(51) Int. Cl. G06F 16/9535; G06F 16/9536; G06F 16/9538; G06F 16/9537

(52) U.S. Cl. CPC G06F 16/9535; G06F 16/9537; G06F 16/9538; G06F 16/9536

(57) ABSTRACT

Methods, apparatuses, systems, and computer program products for matching musical artists automatically are disclosed herein. In preferred embodiments, a request for musical matches is received from a first device. The request includes a first dataset of musical preference selections from a plurality of musical preference categories, with the first dataset being associated with a first user. A comparison of the first dataset is performed with a second dataset of musical preference selections from the plurality of musical preference categories, with the second dataset being associated with a second user. The first device is then prompted to display a name of the second user if at least a predetermined amount of the first dataset is the same as the second dataset.

### CROSS-REFERENCE TO RELATED APPLICATION

This application claims the benefit of priority of U.S. provisional application No. 63/070,260, filed Aug. 26, 2020, the contents of which are herein incorporated by reference.

### BACKGROUND OF THE INVENTION

The present invention relates to musical artist matching and, more particularly, to a method of matching a first individual with another individual based on various criteria within a platform as it relates to the first individual's musical and or video preferences.

Independent artist and creators have long struggled to collaborate with others that are not near their location. Finding and executing these collaborations requires a significant amount of time and effort that can be used otherwise to fulfill their vision artistically, because there is no well-understood or conventional activity an artist may utilize to quickly identify other artists to collaborate with. He/she must seek others out his/herself and has no way of identifying other independent artists/creators with shared visions, abilities, interests, etc. without resorting to directly speaking with each potential candidate.

Consequently, independent creators must dedicate a large portion of their efforts to create their own network of connections to create musical outputs (e.g., songs, music videos). No platform exists that actively helps independent creators create and maintain their own network of other independent creators. The current landscape of how musical connections are established does not have a defined, easily predictable/determinable procedure, and to establish connections costs time, money and is largely dependent upon who knows who.

As can be seen, there is a need for a platform that ameliorates the aforementioned problems for independent artists/creators.

### SUMMARY OF THE INVENTION

In one aspect of the present invention, a computer-implemented method for matching musical artists includes the steps of: receiving, from a first device, a request for musical artist matches, the request comprising a first dataset of musical preference selections from a plurality of musical preference categories, the first dataset of musical preference selections being associated with a first user; performing a comparison of the first dataset with a second dataset of musical preference selections from the plurality of musical preference categories, the second dataset being associated with a second user; and prompting the first device to display a name of the second user if at least a predetermined amount of the first dataset is the same as the second dataset.

In another aspect of the present invention, a system for matching musical artists is disclosed. The system includes at least one processor and at least one memory including computer program code, the at least one memory and the computer program code configured to, with the processor, cause the apparatus to at least: receive, from a first device, a request for musical artist matches, the request comprising a first dataset of musical preference selections from a plurality of musical preference categories, the first dataset of musical preference selections being associated with a first user; perform a comparison of the first dataset with a second dataset of musical preference selections from the plurality of musical preference categories, the second dataset being associated with a second user; and prompt the first device to display a name of the second user if at least a predetermined amount of the first dataset is the same as the second dataset.

In yet another aspect of the present invention, a computer program product for matching musical artists is disclosed. The computer program product includes at least one non-transitory computer-readable storage medium having computer-executable program code instructions stored therein, the computer-executable program code instructions comprising program code instructions for: receiving, from a first device, a request for musical artist matches, the request comprising a first dataset of musical preference selections from a plurality of musical preference categories, the first dataset of musical preference selections being associated with a first user; performing a comparison of the first dataset with a second dataset of musical preference selections from the plurality of musical preference categories, the second dataset being associated with a second user; and prompting the first device to display a name of the second user if at least a predetermined amount of the first dataset is the same as the second dataset.

These and other features, aspects and advantages of the present invention will become better understood with reference to the following drawings, description and claims.

### BRIEF DESCRIPTION OF THE DRAWINGS

FIG. 1A is a flow chart of an embodiment of the present invention;

FIG. 1B is a continuation of the flow chart of FIG. 1;

FIG. 2 is a schematic view of the embodiment of the present invention, showing basic components thereof;

FIG. 3A is a schematic view of the embodiment of the present invention, showing a graphical user interface (GUI) input screen for the profile(s) a user best identifies with;

FIG. 3B is a schematic view of the embodiment of the present invention, showing an alternative GUI input screen for the profile(s) a user best identifies with;

FIG. 4A is a schematic view of the embodiment of the present invention, showing a GUI input screen for music preferences/variables a systemic software application analyzes;

FIG. 4B is a schematic view of the embodiment of the present invention, showing an alternative GUI input screen for musical preferences/variables to be analyzed by the systemic software application;

FIG. 5 is a schematic view of the embodiment of the present invention, showing a GUI input screen for an optional musical preference ranking to be analyzed by the artist matching platform;

FIG. 6 is a schematic view of the embodiment of the present invention, showing a GUI input screen for user personal data;

FIG. 7 is a schematic view of the embodiment of the present invention, showing a GUI output screen for matched artists;

FIG. 8 is a schematic view of the embodiment of the present invention, showing a GUI output screen for matched artists, similar to FIG. 7, and a subsequent pop-up screen with user prompts; and

FIG. 9 is a schematic view of the embodiment of the present invention, showing a GUI screen with a list of established and pending collaborations, as well as feedback by the user regarding the collaborators.

### DETAILED DESCRIPTION OF THE INVENTION

The following detailed description is currently the best contemplated modes of carrying out exemplary embodiments of the invention. The description is not to be taken in a limiting sense, but is made merely for the purpose of illustrating the general principles of the invention, since the scope of the invention is best defined by the appended claims.

Broadly, one embodiment of the present invention is a computer-implemented method for matching musical artists automatically. As part of this method, a request for musical matches is received from a first device. The request includes a first dataset of musical preference selections from a plurality of musical preference categories, with the first dataset being associated with a first user. A comparison of the first dataset is performed with a second dataset of musical preference selections from the plurality of musical preference categories, with the second dataset being associated with a second user. The first device is then prompted to display a name of the second user if at least a predetermined amount of the first dataset is the same as the second dataset.

The present invention enables independent artists, producers, and videographers to connect with other users effectively and efficiently by providing them with connections based on music variables, geography, and previous connections/collaboration to create endless possibilities for musical outputs. The systemic software application (also referred to as an artist matching platform), described herein, references musical variables, geography, and previous connections to help artists establish meaningful collaborations to attribute to one's artistic vision.

The present invention provides solutions to problems in the music industry, specifically for independent creators. The present invention aids the enhancement by creating fluidity and ease in which connections are made between independent creators to create leveled playing field in the music industry, help maintain a network of connections and an infinite number of musical outputs. The method of matching a first user with another user via the platform is a critical aspect of the present invention. The first user's musical and/or video preferences and other variables, such as personal music/sound preference, tempo or beat per minute, instruments or other methods used to create the sound, other musical genre preferences and previous collaborations are factors that are analyzed by the systemic software application when determining potential outputs (i.e., matches for the first user). The first user's geological location will be recommended and preferred, but ultimately optional given that the first user may collaborate with another party through other forms of telecommunications.

System Architecture

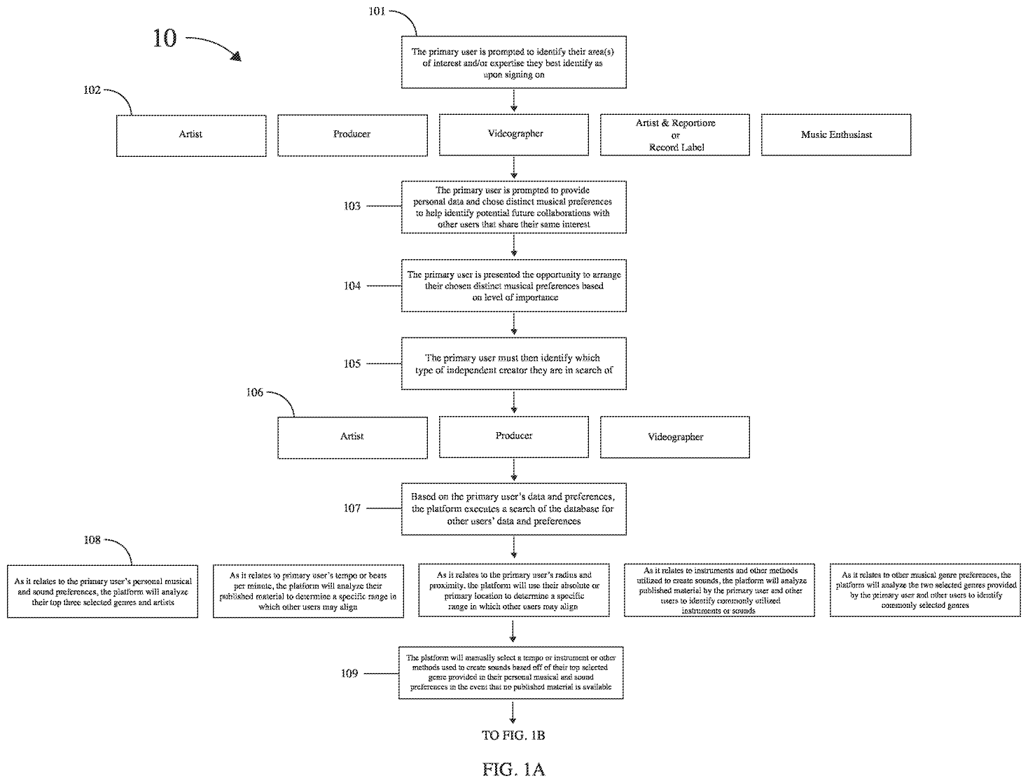

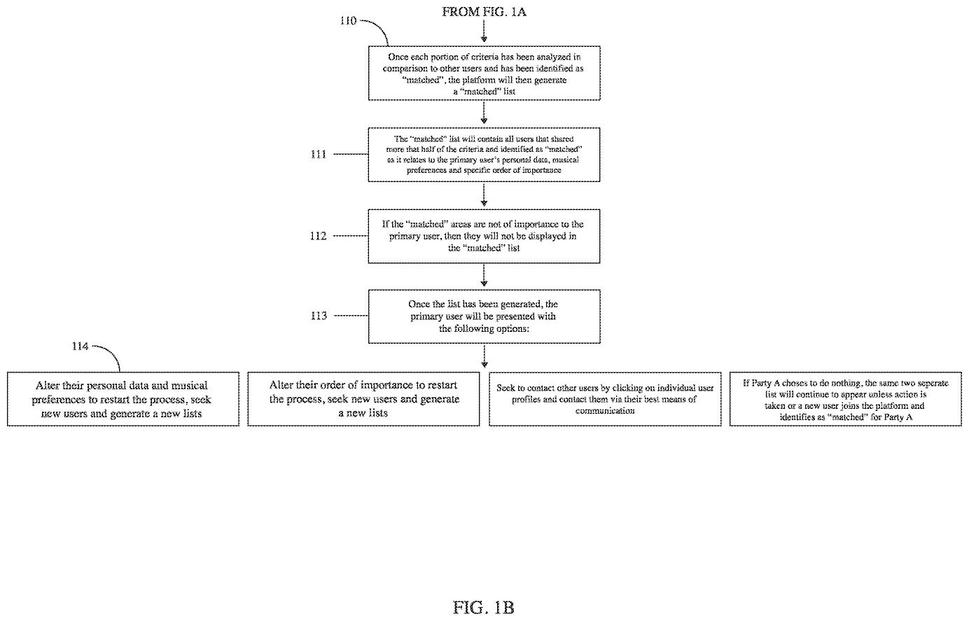

Referring to FIGS. 1A-9, the present invention includes a system of automated artist matching. The system includes at least one computing device (such as a laptop 12 or a smart phone 16) having a processor and a memory. The memory includes software in the form of computing device-executable instructions that, when executed by the processor, cause the processor to implement: a communications interface for communicating with a server 14, various user interfaces 16a-16g, and an artist matching platform.

The computing device includes at least the processor 102 and the memory. The computing device may include a smart phone 16, a tablet computer, a laptop 12, a desktop, and the like. The computing device may execute on any suitable operating system such as IBM's zSeries/Operating System (z/OS), MS-DOS, PC-DOS, MAC-iOS, WINDOWS, UNIX, OpenVMS, ANDROID, an operating system based on LINUX, or any other appropriate operating system, including future operating systems.

In particular embodiments, the computing device includes the processor, the memory, the user interfaces 16a-16g, and the communication interface. In particular embodiments, the processor includes hardware for executing instructions, such as those that constitute a computing device program. The memory includes a main memory for storing instructions, such as computing device program(s) for the processor to execute, or data for the processor to operate on. The memory may be an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to the computing device, where appropriate. In certain embodiments, the memory may be non-volatile, solid-state memory.

The user interface 16a-16g is for displaying and interacting with the artist matching platform. The user interface 16a-16g includes hardware, software, or both providing one or more interfaces for user communication with the computing device. As an example, and not by way of limitation, the user interface may include a keyboard, keypad, microphone, monitor, mouse, printer, scanner, speaker, still camera, stylus, tablet, touchscreen, trackball, video camera, another user interface or a combination of two or more of these.

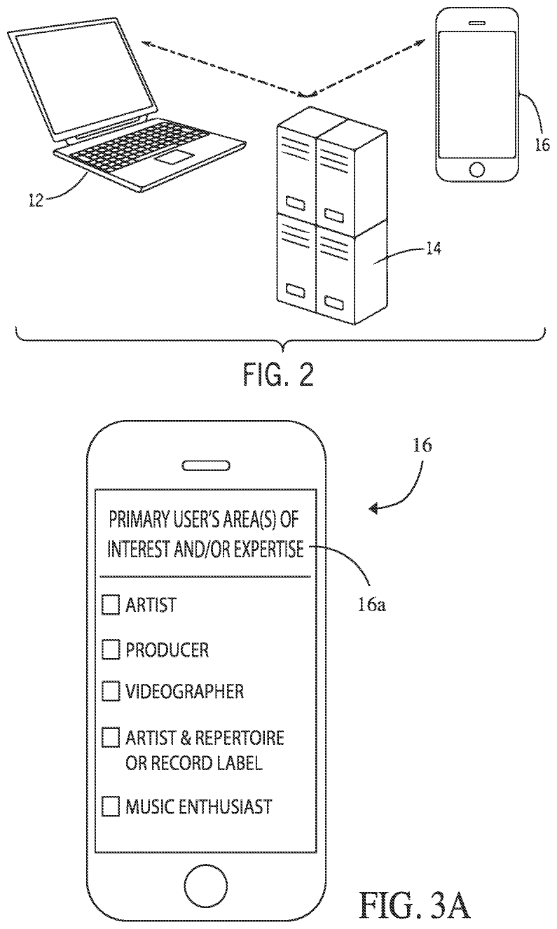

The communications interface is for accessing a server 14 (which, for example, may be a server hosting the artist matching platform) over a network (generally denoted by the dashed lines in FIG. 2). The communication interface includes hardware, software, or both providing one or more interfaces for communication (e.g., packet-based communication) between the computing device and one or more other computing devices on one or more networks. As an example, and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example, and not by way of limitation, the computing device may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing device may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing device may include any suitable communication interface for any of these networks, where appropriate.

Artist Matching Platform

Generally, the artist matching platform may include a standalone systemic software application or program. The standalone application/program may include a plurality of different user's that create profiles with personal data and those alike. As an artist matching standalone software application, the artist matching platform may include a main page and a plurality of individual user profile pages. The artist matching platform allows users to input musical preferences best suited for themselves, and then automatically recommends matches/suggested pairings based on this information. Once users have been matched with others, the users may message the matched users via a message portal and provide feedback for individuals the user collaborates with.

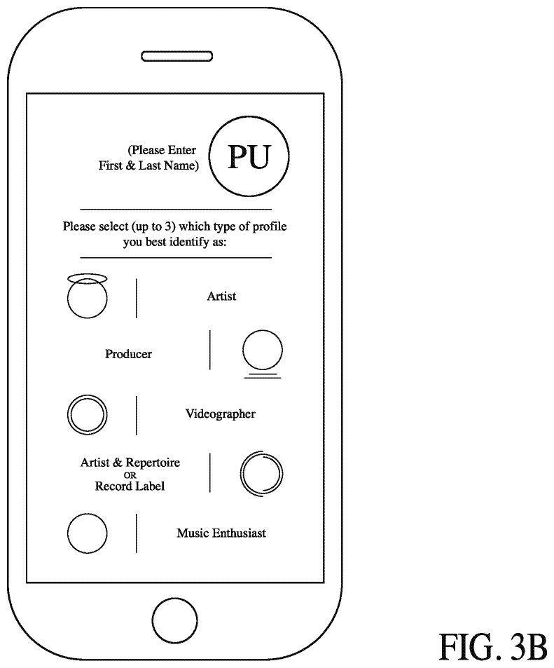

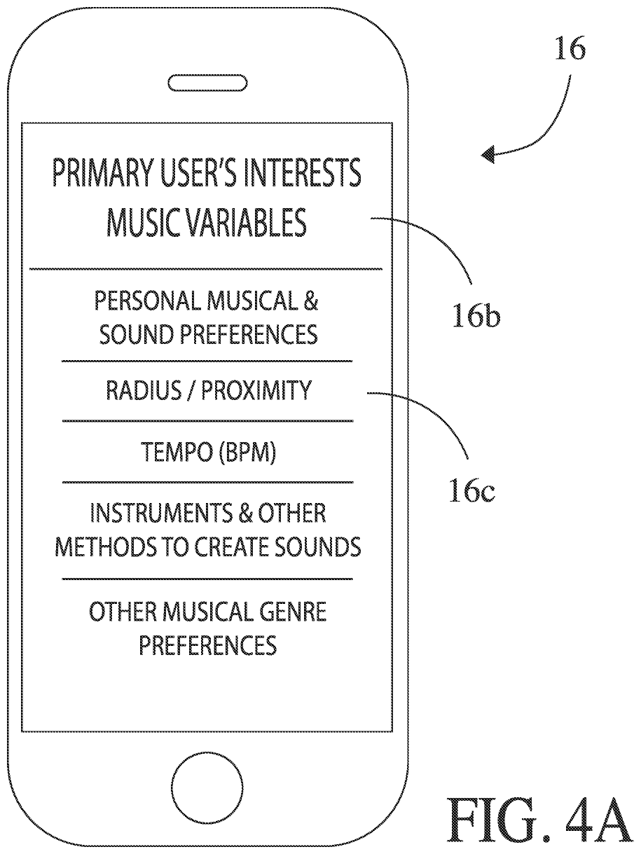

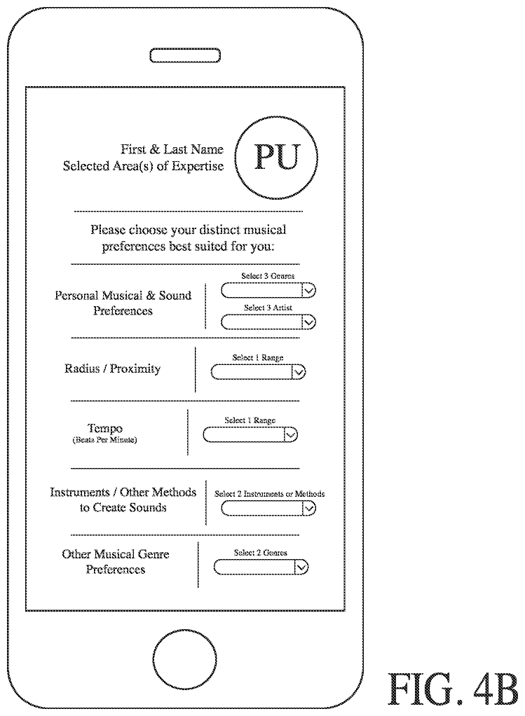

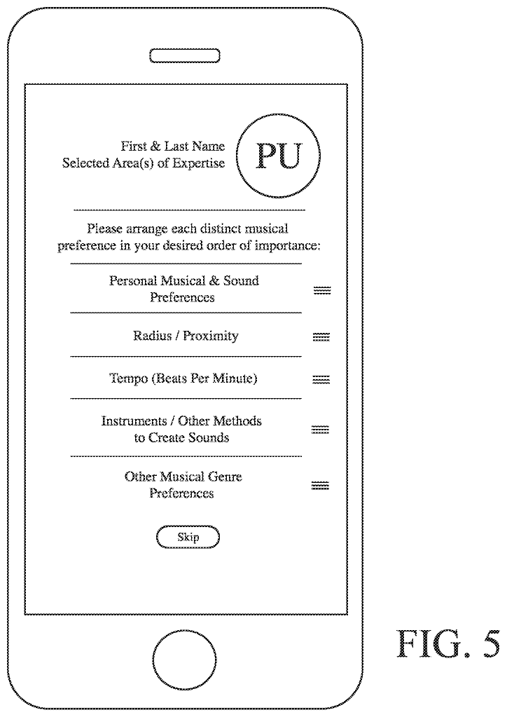

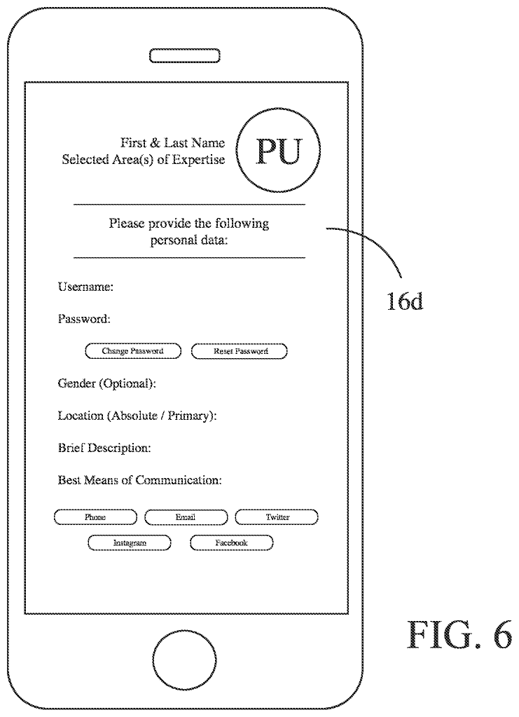

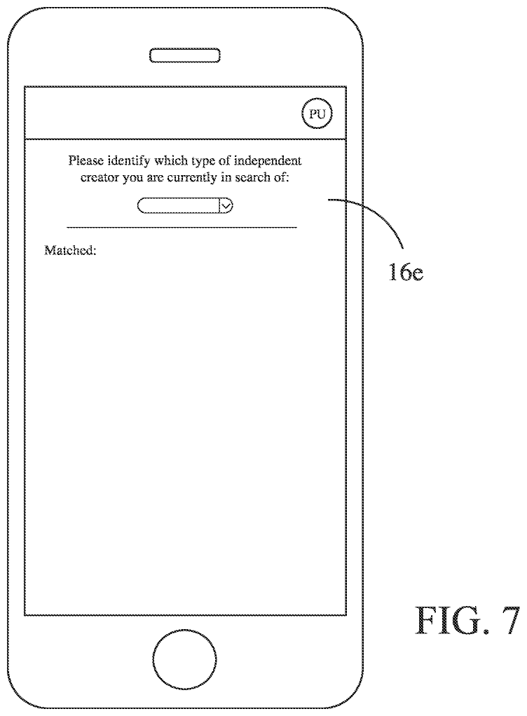

Now referring to FIGS. 1A, 1B, and 3-9, a method of matching artists together may include the following steps. First, beginning at step 101, a primary user is prompted, via the software (e.g., application or website) running on the computing device, to identify which type of profile he or she best identifies with, upon signing on. The types of profiles, shown generally as step 102 and in FIGS. 3A and 3B, may include, but are not limited to: Artist, Producer, Videographer, Artist & Repertoire/Record Label, and Music Enthusiast. The primary user is also prompted to choose distinct musical preferences 16b (FIGS. 4A and 4B being exemplary GUIs showing how this screen might look) to help identify potential future collaborations with other users that share the primary user's same interest, as shown in step 103 and described in greater detail below. The primary user is then prompted to arrange his/her chosen and distinctive musical preferences based on level of importance, as shown in step 104 and FIG. 5. As seen at the bottom of FIG. 5, the primary user may skip this step if he/she does not have any particular importance tied to any of the categories. The primary user is then prompted on another GUI 16d, via the software running on the computing device, to provide personal data (FIG. 6), which may include: name (first and last); username; password; absolute/primary location (which may be, for example, a home address or primary residence); area(s) of expertise; gender (optional); profile photo; brief description of user; and best means of communication. Next, step 105 includes the primary user being prompted 16e to identify which type of independent creator he/she is in search of, with the options being: Artist, Producer, and Videographer (see step 106 and FIG. 7).

Based on data and preferences input by the primary user, the artist matching platform, via the software running on the computing device, executes a search of a user database hosted on the server 14 for other user's personal data and chosen/selected distinctive musical preferences (which form a dataset) from musical preference categories (as described in greater detail below). The matching system works by identifying common/shared musical preferences (which is derived from the input screen shown in either FIG. 4A or 4B) between the primary user and other users of the platform to determine if both parties being compared (the primary user and another user) fall into a “matched” classification or not, as shown generally at steps 107-110. The artist matching platform uses a combination, as described in greater detail below, of the criteria selected by the primary user and his/her preferences in the order of importance to determine compatibility (and provide a corresponding output). If no order of importance is indicated (i.e., the GUI shown in FIG. 5 is skipped), only selections to the criteria factor into the matching system.

The following are exemplary criteria/categories 16c as to how the platform analyzes potential matches. It should be understood that other musical preferences are envisioned in accordance with the present invention, as well as other ranges, music genres, instruments, etc., rather than the ones herein described. Each of the preferences, data, categories and or subcategories may be subject to change, for example, upon further review and feedback from users to ultimately create a platform that is both optimal and efficient. Further, the descriptions here are in no particular order, and the categories are arranged in an order of importance once a specific order has been identified by the primary user.

As shown, for example, in FIG. 4B, the first musical category for input by the primary user (and other users who use the platform) is personal musical/sound preferences. A primary user is prompted to select three music genres and three musical artists that the primary user identifies most with in terms of his/her own musical style. In certain embodiments, the three music genres and musical genres may be selected in a manner that they are ranked (e.g., the first selected music genre corresponds to the top/favorite genre of the primary user). The music genres and musical artists populated in these lists are predetermined and may be changed in accordance with the present invention. Exemplary music genres to select from include: reggae; R&B; lo-fi; alternative; indie; slowed/chopped; hip-hop; soul; pop; heavy metal; rock; jazz; funk; techno; and trap. The primary user is also prompted to select three popular artists, with this list of artists being generated based upon the three genre selections made. By way of example, a selection of the genre “Rock” may result in music artists being displayed such as: THE BEATLES™, FLEETWOOD MAC™, QUEEN™, etc. In certain embodiments, the popular artists listings may be pulled from current charting information provided by various music charting brands, such as BILLBOARD™, APPLE MUSIC™, and/or SPOTIFY™. For this category, the platform executes a comparison of the six selections made by the primary user to the corresponding selections by other users of the platform, which are stored on the other user profiles in the database on the server 14. In preferred embodiments, if four or more of the same genres and artists are selected by the primary user and the other user being compared, a classification of “matched” is assigned to this category. Conversely, less than this would result in an “un-matched” classification. Variations to this are in accordance with the present invention. For example, another number of genres in common could be selected, as well as the potential for matches to be calculated based on a percent match (e.g., how many shared genres exist between the users being compared).

As shown, for example, in FIG. 4B, the second musical category for input by the primary user (and others who use the platform) is radius/proximity, which corresponds to a distance a primary user is willing to travel based on the absolute/primary location input by the primary user. Exemplary radii/proximities that may be used are: 0-25 miles, 26-50 miles, 76-100 miles, or 100+ miles. For this category, the platform executes a comparison of locations (the location of the primary user and the location of the other user being compared) and the distance the primary user is willing to travel. In preferred embodiments, a classification of “matched” is assigned to this category if the user being compared with the primary user is located within the range selected by the primary user. Conversely, greater than this range would result in an un-matched classification. Variations to this are in accordance with the present invention. For example, another distance range could be selected, as well as the potential for matches to be calculated based on a percent match (e.g., on the basis of how close the users are being compared).

As shown, for example, in FIG. 4B, the third musical category for input by the primary user (and others who use the platform) is tempo (quantified by beats per minute). For this category, the primary user is prompted to select an average tempo range he/she most aligns with stylistically. An alternative way of determining an average tempo for the primary user and other users of the platform includes automatically analyzing published material (in a manner similar to as described above) of the users to calculate an average beats per minute (bpm) for each user on the platform. Another way (this is optional and only occurs in certain embodiments, see step 109) of determining an average tempo for each user includes basing the average tempo determination based upon the top genre selected in the first category (personal music and sound preferences—see above description regarding how the top genre is determined). Exemplary tempos for a primary user to choose from include: 60-90 bpm (e.g., reggae); 60-80 (e.g., R&B/lo-fi); 70-100 bpm (slowed/chopped); 85-115 bpm (e.g., hip-hop); 90-120 bpm (e.g., soul); 100-130 bpm (e.g., pop); 100-140 bpm (e.g., heavy metal); 110-140 bpm (e.g., rock); 120-125 bpm (e.g., jazz/funk); 120-160 bpm (e.g., techno); and 140+ bpm (e.g., trap). In preferred embodiments, for this category, the platform executes a comparison of the calculated/selected tempo of the primary user and the user being compared, and if the average tempo of the two users being compared is within 20 bpms, a classification of “matched” is assigned to this category. Conversely, if the average tempo of the two users being compared varies by more than 20 bpms, an “un-matched” classification would result. Variations to this are in accordance with the present invention. For example, another distance range could be selected, as well as the potential for matches to be calculated based on a percent match (e.g., on the basis of how close the users are being compared).

As shown, for example, in FIG. 4B, the fourth musical category for input by the primary user (and others who use the platform) is instruments/other methods to create sounds. For this category, the primary user is prompted to select methods of making sound he/she most aligns with stylistically. An alternative way of determining an instruments/methods of making sounds for the primary user and other users of the platform includes automatically analyzing published material (which may be accomplished, for example, by another program or process to be initiated in the background of the platform or interface once material is posted by the primary user) of the users. Another way (this is optional and only occurs in certain embodiments, see step 109) of determining an instruments/methods of making sounds for each user includes basing the instrument determination based upon the top genre selected in the first category (personal music and sound preferences—see above description regarding how the top genre is determined). For example, if the top genre selected is “hip-hop”, the most commonly used instrument/method of creating sound would be categorized as “computerized sounds”. Exemplary instruments for a primary user to choose from include but are not limited to: keyboard (including piano, synth, organ, etc.); strings (including guitar, bass, violin, etc.); percussion (including drums, xylophone, tambourine, etc.); electronic or computerized sounds (including kicks, hats, 808s, etc.); and other existing sounds or samples. In preferred embodiments, for this category, two instruments/methods of making sound must be selected, and the platform executes a comparison of the determined/selected instruments of the primary user and the user being compared, and if two or more commonly used instruments/methods of making sounds are in common, a classification of “matched” is assigned to this category. Conversely, if there is one or no commonly utilized instruments/methods of making sound in common between the two users being compared, an “un-matched” classification would result. Variations to this are in accordance with the present invention. For example, a differing amount of instruments/sounds to be selected may be employed, as well as a different cutoff for how many of the instruments/sounds must be in common to constitute a “matched” classification.

As shown, for example, in FIG. 4B, the fifth musical category for input by the primary user (and others who use the platform) is other musical genre preferences. For this category, the primary user is prompted to select two music genres that the primary user is willing to experiment with. The following are exemplary genres that may be a part of a list for the primary user to choose from: reggae; R&B; lo-fi; alternative; indie; slowed/chopped; hip-hop; soul; pop; heavy metal; rock; jazz; funk; techno; and trap. In preferred embodiments, for this category, the platform executes a comparison of the selected genres of the primary user and the user being compared, and if both genres are the same for both users, a classification of “matched” is assigned to this category. Conversely, if one or fewer of the selected genres are in common, an “un-matched” classification would result. Additionally, a user's selections for the first category may be appropriate to be analyzed for this category as well. For example, if the primary user selects “reggae” as a musical genre he/she is willing to experiment with, and the user being compared indicated for the first category that “reggae” is a musical/sound preference, the platform would classify reggae as a match for this category.

Making reference now to FIG. 1B, specifically step 110, once the artist matching platform has analyzed each category of the primary user in comparison with another user of the platform, and repeats the process described above for every user in the platform database, a “matched” list is generated (see step 110). The “matched” list corresponds to all users that shared more than half (e.g., 3) of the criteria (of the five described above) and identified as “matched” as it relates to the primary user's personal data, musical preferences, and specific order of importance (see step 111). If the “matched” areas are not of importance to the primary user (e.g., if two out of three of matching categories are ranked as the 4^{th} and 5^{th} most important categories, those categories will not be counted as “matched”), then they will not appear in the “matched” list (see step 112). In the presently described embodiment, “of importance” refers to a condition where the primary user has ranked the five categories, with the top three ranked categories being considered important to the primary user and the bottom two being considered unimportant. All evaluation criterion is subject to change or expansion based upon the request of current users to meet the needs of each user and advance the platform to create more effective and efficient connections and or collaborations.

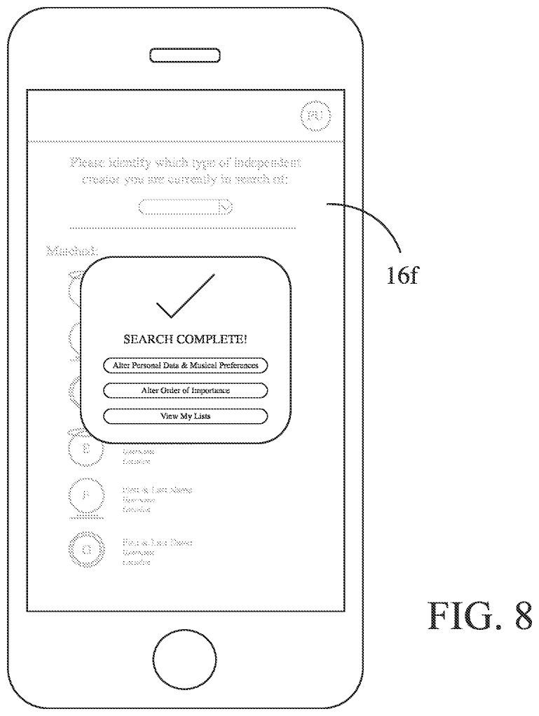

Once each list has been generated, as shown by step 114 and FIG. 8, a user is presented with the following exemplary options (see step 113): to alter his/her personal data and musical preferences, to alter order of importance, or view his/her lists to contact users. In certain embodiments, when a primary user selects “View My Lists” the completion notification “bubble” will disappear from the GUI view and the primary user will be able to view the list that has just been generated based on the primary users' user type selection. A new list will be generated every time the primary user executes a search of the database for a specific user type. The primary user cannot save previous runs; however, the same users may appear from the previous runs when another search is executed. Selecting the option to alter his/her personal data and or musical preferences results in a restart of the process to generate a new list. Altering the order of importance also results in a restart to the process (starting at step 104) to generate a new list. Seeking to contact users may be done by clicking on user profiles and contacting them through their “best means of communication”. If the primary user chooses to do nothing, the same list will continue to appear unless action is taken or a new user which joins the platform and identifies as “matched” for the primary user. In this event, the primary user may be notified if a new user joins the platform and identifies as “matched” based off of the primary user's personal data, musical preferences and their current order of importance.

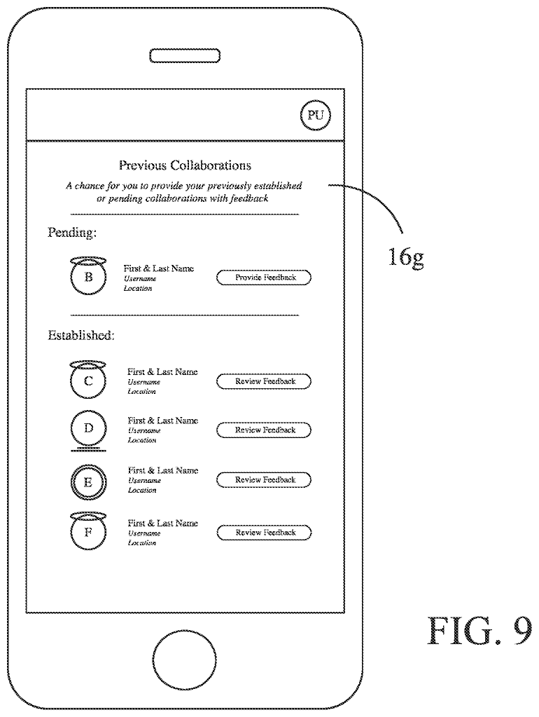

As shown in FIG. 9, after a previously established collaboration has been created, such as a musical output posted on the platform (there is a place (not shown) provided on the platform for musical uploads that can be viewed by others for feedback or constructive criticism), both parties will be prompted to rate one another on a scale of 1-10, 1 being the worst, 10 being the best, based on the following criteria: responsiveness/willingness to collaborate; open-mindedness; knowledge of area(s) of expertise; level of productivity/efficiency; and friendliness. Further, both parties will also be prompted to respectfully generate additional dissatisfactory comments or concerns, if necessary. Based off of the rating for each portion of the criteria, an average score may be determined and may be later utilized to rank all previous collaborations from best to worst. A user may use this ranking as a basis for determining future collaborations with users he/she has previously collaborated with.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as steps, without loss of generality. The described operations and their associated steps may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method for matching musical artists, the method comprising:
receiving, from a first device, a request for musical artist matches, the request comprising a first dataset of musical preference selections from a plurality of musical preference categories, the first dataset of musical preference selections being associated with a first user;
performing a comparison of the first dataset with a second dataset of musical preference selections from the plurality of musical preference categories, the second dataset being associated with a second user; and
prompting the first device to display a name of the second user if at least a predetermined amount of the first dataset is the same as the second dataset.

2. The computer-implemented method of claim 1, wherein the plurality of musical preference categories comprises at least five musical preference categories, and the first dataset comprises at least one musical preference selection from each of the at least five musical preference categories.

3. The computer-implemented method of claim 2, wherein the predetermined amount includes the same musical preference selections in the first dataset and the second dataset in at least three of the at least five musical preference categories.

4. The computer-implemented method of claim 1, wherein the first dataset is organized in a ranked order, and at least one musical preference selection at a bottom of the ranked order is not compared to the second dataset.

5. The computer-implemented method of claim 1, wherein the plurality of musical preference categories is at least two musical preference categories selected from the group consisting of: (i) musical and sound preferences, (ii) proximity to other music artists, (iii) preferred playing tempo, (iv) instruments or other ways to create sounds, and (v) other music genre preferences.

6. A system for matching musical artists, the system comprising at least one processor and at least one memory including computer program code, the at least one memory and the computer program code configured to, with the processor, cause the system to at least:
receive, from a first device, a request for musical artist matches, the request comprising a first dataset of musical preference selections from a plurality of musical preference categories, the first dataset of musical preference selections being associated with a first user;
perform a comparison of the first dataset with a second dataset of musical preference selections from the plurality of musical preference categories, the second dataset being associated with a second user; and
prompt the first device to display a name of the second user if at least a predetermined amount of the first dataset is the same as the second dataset.

7. The system of claim 6, wherein the plurality of musical preference categories comprises at least five musical preference categories, and the first dataset comprises at least one musical preference selection from each of the at least five musical preference categories.

8. The system of claim 7, wherein the predetermined amount includes the same musical preference selections in the first dataset and the second dataset in at least three of the at least five musical preference categories.

9. The system of claim 6, wherein the first dataset is organized in a ranked order, and at least one musical preference selection at a bottom of the ranked order is not compared to the second dataset.

10. The system of claim 6, wherein the plurality of musical preference categories is at least two musical preference categories selected from the group consisting of: (i) musical and sound preferences, (ii) proximity to other music artists, (iii) preferred playing tempo, (iv) instruments or other ways to create sounds, and (v) other music genre preferences.

11. A computer program product for matching musical artists, the computer program product comprising at least one non-transitory computer-readable storage medium having computer-executable program code instructions stored therein, the computer-executable program code instructions comprising program code instructions for:
receiving, from a first device, a request for musical artist matches, the request comprising a first dataset of musical preference selections from a plurality of musical preference categories, the first dataset of musical preference selections being associated with a first user;
performing a comparison of the first dataset with a second dataset of musical preference selections from the plurality of musical preference categories, the second dataset being associated with a second user; and
prompting the first device to display a name of the second user if at least a predetermined amount of the first dataset is the same as the second dataset.

12. The computer program product of claim 11, wherein the plurality of musical preference categories comprises at least five musical preference categories, and the first dataset comprises at least one musical preference selection from each of the at least five musical preference categories.

13. The program product of claim 12, wherein the predetermined amount includes the same musical preference selections in the first dataset and the second dataset in at least three of the at least five musical preference categories.

14. The computer program product of claim 11, wherein the first dataset is organized in a ranked order, and at least one musical preference selection at a bottom of the ranked order is not compared to the second dataset.

15. The computer program product of claim 1, wherein the plurality of musical preference categories is at least two musical preference categories selected from the group consisting of: (i) musical and sound preferences, (ii) proximity to other music artists, (iii) preferred playing tempo, (iv) instruments or other ways to create sounds, and (v) other music genre preferences.
